(19) United States
(12) Patent Application Publication
(10) Pub. No.: US 2023/0277968 A1
(43) Pub. Date: Sep. 7, 2023

(54) FILTER CANDLE HAVING A CONCENTRATION GRADIENT OF CATALYST METALS, METHOD FOR PRODUCTION THEREOF AND USE THEREOF IN AN EXHAUST GAS CLEANING METHOD

(71) Applicant: Rath GmbH, Meissen (DE)

(72) Inventors: Vera FINKE, Eppstein (DE); Michael STAEPS, Dresden (DE); Sylvia OTTO, Freiberg (DE)

(73) Assignee: Rath GmbH, Meissen (DE)

(21) Appl. No.: 18/008,160

(22) PCT Filed: Jun. 1, 2021
(86) PCT No.: PCT/EP2021/064675

§ 371 Date: Dec. 2, 2022

(30) Foreign Application Priority Data
Jun. 5, 2020 (DE) 10 2020 115 015.6

(51) Int. Cl. B01D 39/20; B01D 46/00; B01D 46/24; B01D 53/88

(52) U.S. Cl. CPC B01D 39/2082; B01D 46/0001; B01D 46/2407; B01D 53/885; B01D 2258/01; B01D 2255/20707; B01D 2255/20723; B01D 2275/30; B01D 2279/60

(57) ABSTRACT

The present invention relates to a hollow filter candle (1) which has, via impregnation of the inside with a catalyst solution, a concentration gradient of catalyst metals from the inside to the outside across the wall thickness thereof. The present invention furthermore relates to a method for producing a filter candle (1) according to the invention and the use of the filter candle (1) according to the invention for exhaust gas cleaning, in particular in waste incineration plants.

The present invention relates to a hollow filter candle which, through impregnation of the inside with a catalyst solution, has a concentration gradient of catalyst metals from the inside to the outside across its wall thickness. The present invention further relates to a method for producing a filter candle of the invention and to the use of the filter candle of the invention for exhaust gas cleaning, more particularly for cleaning industrial exhaust gases, preferably for cleaning exhaust gases from waste incineration plants.

### PRIOR ART

Exhaust gases from industrial processes, arising for example in waste incineration or in the cement, glass, and chemical industries, frequently contain toxic and noxious substances, such as dioxins, furans, nitrogen oxides, sulfur- and chlorine-containing compounds, fine dust, and soot. In order for such exhaust gases to be able to be emitted safely to the environment, they must be filtered beforehand in order to remove the toxic and noxious substances.

Gaseous noxiants are traditionally removed by so-called “gas scrubbing”, in which a particulate material is injected into the exhaust gas. This particulate material reacts chemically and/or physically with the gaseous substances in the exhaust gas to form particulate reaction products. The exhaust gas treated in this way is subsequently filtered by means of a filter, examples being textile bag filters, metal filters or filters made from inorganic fibers, such as filter candles. In the case of textile bag filters, the filter element is generally a cylindrical bag which comprises a supporting fabric with fibers applied thereon as filter material. Bag filters are used for filtration at low and medium temperatures of up to about 250° C. Conversely, filter candles having a filter body made of inorganic fibers (such as, for instance, ceramic fibers, vitreous fibers, high-temperature wools, carbon fibers) may be used for filtration of gases at up to 1000° C.

The particulate reaction products and also other solids present in the exhaust gas are retained as a dust cake on the surface of the filter. This dust cake can be removed by supplying the filter with clean compressed air from the reverse side.

To increase the filter efficiency, it is known practice in the prior art to increase the size of the filters and hence the throughput. This, however, is detrimental to the stability properties, as it also increases the weight of the filter and hence the tensile stresses which load the filter, on account of its own weight, during operation. It is also known practice in the prior art to increase the filter efficiency by impregnating the filters with metal salt solutions. Impregnation takes place usually after the production of the filter, by application of the metal salt solution to the surface or by immersion of the filter in the metal salt solution with subsequent drying of the impregnated filter. Following a subsequent thermal activation, catalytically active metal compounds are obtained. As well as dedusting, this also enables the decomposition of toxic gases, such as nitrogen oxides, for example.

A filter element of this kind composed of inorganic fibers and a reactant is described for example in EP 1 497 011 B1, the reactant being located in a position with a uniform distribution across the entire filter element, and comprising a catalyst.

However, the solids contained in the exhaust gas are deposited predominantly on the surface of the filter, and so the catalytically active metals applied there very quickly become blocked by these solids and hence are no longer available for the decomposition of toxic gases, such as nitrogen oxides, for example. Moreover, the known catalysts used, such as vanadium pentoxide, for example, have poor environmental compatibility, and it is therefore desirable to reduce the amount of these catalysts when producing the filters, but without adversely affecting the filter performance.

There is therefore a demand for filters, especially filter candles for exhaust gas cleaning, preferably for exhaust gas cleaning in waste incineration plants, for which the use of metal salt solutions during their production can be reduced, albeit without significantly detracting from the filter performance obtained with these filters or from the mechanical properties.

### OBJECT OF THE INVENTION

The object of the present invention, accordingly, was that of providing a filter candle for exhaust gas cleaning for whose production a reduced amount of catalytically active metal salts can be used, albeit without detracting significantly from the filter and exhaust gas cleaning performance or from the mechanical stability of this filter candle.

### Achievement of the Object

The object is achieved by a filter candle for exhaust gas cleaning, the filter candle being obtainable by:
a) providing a hollow filter candle body
b) impregnating the inside of the filter candle body provided in step a) with a catalyst solution comprising at least one solvent, preferably water, and at least one metal compound dissolved and/or dispersed in the at least one solvent,
c) drying the impregnated filter candle body obtained in step b), and
d) thermally activating the filter candle body obtained in step c).

The object is additionally achieved by a filter candle for cleaning exhaust gases, more particularly for cleaning industrial exhaust gases, preferably for cleaning exhaust gases from waste incineration plants, comprising a hollow filter candle body and at least one catalytically active metal compound, characterized in that the wall of the filter candle body has a concentration gradient of the catalytically active metal compound.

Furthermore, the object is achieved by a method for producing a filter candle of the invention, the method comprising the following method steps in the specified order:
a) providing a hollow filter candle body
b) impregnating the inside of the filter candle body provided in step a) with a catalyst solution comprising at least one solvent, preferably water, and at least one metal compound dissolved and/or dispersed in the at least one solvent,
c) drying the impregnated filter candle body obtained in step b), and
d) thermally activating the filter candle body obtained in step c).

The object is achieved, moreover, by the use of a filter candle of the invention or of the filter candle obtainable from the methods of the invention for exhaust gas cleaning, more particularly for cleaning industrial exhaust gases, preferably for cleaning exhaust gases from waste incineration plants.

The object is achieved, lastly, by an apparatus for producing a filter candle, the apparatus comprising a reservoir vessel for the catalyst solution, said vessel being provided optionally with a stirring facility and there being a conduit which starts from the reservoir vessel and via which the catalyst solution can be conveyed by means of a conveying facility into a spraying lance which is held moveably in longitudinal direction, for the inside impregnation of the filter candle body, the apparatus further comprising a holder for the filter candle body that is equipped optionally with a drive unit for setting the filter candle body into rotation about its longitudinal axis.

The invention is based on the finding that filter candles in operation are typically traversed by a flow of the exhaust gases to be cleaned, from outside to inside. In the course of this flow, the dust is retained first of all on the outer surface, and so the exhaust gases substantially freed from the dust accordingly are cleaned by the metal catalysts present as the exhaust gases flow through the porous filter candle wall. In the development work leading to the present invention, however, it was observed that these metal catalysts become blocked by the dust and therefore the metal catalysts present on the outside face of the filter candle no longer make a full contribution to the cleaning of the exhaust gases. On this basis it was recognized that for a high filter performance, it is sufficient for the concentration of the metal catalysts to increase in a gradient from outside to inside. In this way, the amount of aqueous metal salt solution can also be reduced during the production of the filter candles, without detracting significantly from the filter performance. As a result of the reduced usage of the metal salt solution or metal salt suspension, it is possible, first, to achieve an improved environmental balance, since the metal compounds used—as mentioned at the outset—are in some cases toxic. Secondly, the filter candles of the invention can be produced more cost-effectively than filter candles for which the application of the metal compounds takes place by immersion of the entire filter candle in an aqueous metal salt solution or metal salt suspension.

### DETAILED DESCRIPTION OF THE INVENTION

The hollow filter candle body consists preferably of inorganic fibers. The inorganic fibers may be selected from the group of ceramic fibers, glass fibers, crystalline mineral fibers, amorphous mineral fibers, mineral wood, high-temperature wool, carbon fibers, and mixtures thereof. Preference is given to using ceramic fibers, more particularly aluminum silicate fibers.

The filter candles of the invention preferably have a porosity of 70 to 95%, more preferably of 75 to 90%, more particularly of 80 to 90%. The porosity is determined for example by means of determination of the water absorption according to DIN EN 993-1:2019 DE.

According to one preferred embodiment, the filter candle body has a collar element at one end and is closed at the opposite end. The closed end may have, for example, a dome-shaped or flat closure, preference being given to a dome shape.

The filter candle body of the filter candle may be produced by all known techniques. In one preferred embodiment, the filter candle body of the filter candle is obtainable by:
i) preparing a suspension which comprises inorganic fibers and at least one binder system,
ii) drawing the suspension prepared in step i) by suction onto a candle-shaped absorbent core for the shaping of the filter candle body, and
iii) drying the filter candle body shaped in step ii).

The binder system here may comprise starch, starch derivatives or cellulose derivatives such as cellulose ethers, and at least one colloidal dispersion, preferably a silica salt. The filter body may be shaped using all customary shape-imparting processes such as injection molding and vacuum forming, preference being given to vacuum forming, especially for achieving a greater porosity.

The hollow filter candle body is preferably impregnated exclusively on the inside with a catalyst solution. The impregnation may be accomplished, for example, by spray introduction, brushing, coating or the like of the inside of the filter candle body with dissolved or dispersed metal compound. Additionally, small amounts of catalyst solution may be applied from the outside to the filter candle body, provided it is ensured that the concentration of catalyst on the inside of the filter candle is higher than on the outside. Exclusive impregnation from the inside, however, is preferred.

The catalyst solution used comprises at least one solvent and at least one metal compound in dispersion or solution in the at least one solvent. Suitable solvents include all solvents capable of dissolving or dispersing the suitable metal compounds. In the context of the present invention, preference is given to using protic solvents such as water, alcohols, and mixtures thereof. Particularly preferred solvents are water, methanol, ethanol or mixtures thereof. The catalyst solution may also include other commonplace auxiliaries, such as dispersants and/or emulsifiers.

The metal of the metal compound used is selected, for example, from the group encompassing or consisting of platinum, palladium, ruthenium, aluminum, tungsten, titanium, vanadium, and mixtures thereof, more particularly encompassing or consisting of titanium and vanadium, and optionally tungsten. The catalyst solution may have a total content of metal compound(s) of 1 to 10 wt %, preferably of 3 to 8 wt %, more preferably from 4 to 7 wt %, more particularly of 4.5 to 6 wt %, based in each case on the total weight of the catalyst solution.

In another preferred embodiment, the metal of the metal compound is selected from the group encompassing or consisting of titanium and vanadium, the mass ratio of titanium compound(s) to vanadium compound(s) being 100:1 to 10:1, preferably from 75:1 to 15:1, more preferably from 60:1 to 20:1, more particularly of 30:1. In this way it is possible to achieve particularly efficient reduction of nitrogen oxides in the exhaust gas with comparatively favorable catalytically active metals.

The impregnation of the inside of the hollow filter candle body in accordance with the invention generates a concentration gradient of catalytically active metal compound in the wall of the filter candle body. This concentration of catalytically active metal compound decreases from inside to outside. The concentration gradient may be dependent, for example, on the concentration of the catalytically active substance in the spraying solution/spraying suspension, on the solvent or solvent mixture used, on the spraying duration and spraying quantity, on the coating speed, and on the wall thickness, the porosity, and the material used for the filter candle, and may be controlled by adjusting these parameters. In order to determine the concentration of the metal compound(s) in the wall of the filter candle body, for example, a roundel is taken as a sample from the filter candle body, using a hole drill. The concentration in various regions of the roundel across the wall thickness may be taken with all commonplace measurement techniques, those preferred being spectroscopic techniques with spatial resolution, such as energy-dispersive x-ray spectroscopy (EDX) or x-ray fluorescence analysis (XFA), for example. Unless otherwise indicated elsewhere, the concentration here refers to the mass fraction of the catalytically active metal compound(s) (“catalyst” for short) in wt % in the sample taken, and is therefore representative of the concentration of said compound(s) in that region (for example, the wall inside).

As far as the concentration gradient is concerned, the concentration of the catalytically active metal compound(s) on the wall outside of the hollow filter candle body is preferably 1.5 to 90%, more preferably 5 to 85%, very preferably 10 to 80%, more preferably still 20 to 80%, especially preferably 40 to 80%, and more especially preferably 50 to 80% of the concentration of the catalytically active metal compound on the wall inside of the hollow filter candle body of the filter candle.

In an alternative embodiment, the concentration of the catalytically active metal compound(s) on the wall outside of the hollow filter candle body is preferably 1.5 to 25%, more preferably 2.5 to 20%, more particularly 4 to 15%, of the concentration of the catalytically active metal compound on the wall inside of the hollow filter candle body of the filter candle.

The wall thickness of the filter candle body is within the ranges customary for this purpose, preferably between 5 to 50 mm, more preferably between 10 to 30 mm.

In one particularly preferred embodiment of the filter candle of the invention, the concentration of catalytically active metal compound(s) within the wall thickness of the filter candle body after drying is
10 to 30 wt %, preferably 15 to 20 wt % on the wall inside of the filter candle body;
8 to 20 wt %, preferably 10 to 18 wt % in the center of the wall of the filter candle body;
1 to 20 wt %, preferably 5 to 15 wt % on the wall outside of the filter candle body;
   where the concentration of catalytically active metal compound(s) increases in a gradient from outside to inside across the wall thickness of the filter candle body.

In one preferred embodiment of the method of the invention, the impregnation in step b) in the method takes place preferably by means of spraying, more particularly by means of a spraying lance movable in longitudinal direction within the filter candle body.

The drying in step c) takes place, for example, at room temperature or at elevated temperatures of 80 to 120° C., additionally, a reduced pressure may be applied as well.

The thermal activation in step d) may take place in the manner known per se to the skilled person. Accordingly the filter candle body, for example, is heated at 300 to 600° C. for 2 to 20 hours and then cooled back down to room temperature.

In one preferred embodiment of the method of the invention there is a nozzle at the lance tip. Preferred nozzles are of stainless steel, more particularly hollow-cone nozzles. The conveying facility used for the catalyst solution or suspension preferably comprises pumps such as piston pumps, rotary piston pumps, scroll compressors, and the like. The holder is formed preferably by rolls, examples being rubber-coated metal rolls, on which the filter candle body is placed. For the rotation of the filter candle body about its longitudinal axis, rotary motors are installed in one or some of the rolls. The apparatus for producing a filter candle preferably has a suction withdrawal unit in the region above the holder and/or a collecting vessel below the holder for excess catalyst solution or for rinsing water for disposal. These components are typically sized in such a way that they project beyond the filter candle body on all sides.

In one preferred embodiment of the apparatus of the invention, a suction withdrawal unit is positioned in the region above the holder and/or a collecting vessel for excess catalyst solution is positioned below the holder.

The holder of the apparatus of the invention is formed preferably by a plurality of rollers for the rotatable mounting of the filter candle body, with at least one of the rollers being equipped with a drive unit. As an alternative to this, the drive unit may also engage directly on the filter candle body, with the rollers then serving only for the mounting of the filter candle body.

It is preferred, furthermore, for the holder to have a stop facility, movable for example via a rail, for the location of the filter candle body. This stop facility ensures that the filter candle body remains at a defined position even when rotated. The movability of the stop facility here allows filter candle bodies of different lengths to be located.

The invention relates more particularly to the following embodiments:

According to a first embodiment, the invention relates to a filter candle 1 for exhaust gas cleaning, the filter candle 1 being obtainable by:
a) providing a hollow filter candle body 2
b) impregnating the inside 3 of the filter candle body 2 provided in step a) with a catalyst solution comprising at least one solvent, preferably water, and at least one metal compound dissolved and/or dispersed in the at least one solvent,
c) drying the impregnated filter candle body 2 obtained in step b), and
d) thermally activating the filter candle body 2 obtained in step c).

According to a second embodiment, the invention relates to a filter candle according to embodiment 1, characterized in that the filter candle body 2 comprises or consists of inorganic fibers.

In a third embodiment, the invention relates to a filter candle according to embodiment 2, characterized in that the inorganic fibers are selected from the group of ceramic fibers, glass fibers, crystalline mineral fibers, amorphous mineral fibers, mineral wood, high-temperature wool, carbon fibers, and mixtures thereof, preferably ceramic fibers, more particularly aluminum silicate fibers.

In a fourth embodiment, the invention relates to a filter candle according to any of the preceding embodiments, characterized in that the filter candle 1 has a porosity of 70 to 95%, preferably of 75 to 90%, more particularly of 80 to 90%.

According to a fifth embodiment, the invention relates to a filter candle according to any of the preceding embodiments, characterized in that the filter candle body 2 has a collar element 4 at one end and is closed at the opposite end.

According to a sixth embodiment, the invention relates to a filter candle according to any of the preceding embodiments, characterized in that the filter candle body 2 is obtainable by:
i) preparing a preferably aqueous suspension which comprises inorganic fibers and at least one binder system,
ii) drawing the suspension prepared in step i) by suction onto a candle-shaped absorbent core for the shaping of the filter candle body 2, and
iii) drying the filter candle body 2 shaped in step ii).

In a seventh embodiment, the invention relates to a filter candle according to embodiment 6, characterized in that the binder system comprises or consists of starch and at least one colloidal dispersion, preferably silica sol.

According to an eighth embodiment, the invention relates to a filter candle according to any of the preceding embodiments, characterized in that the metal of the metal compound is selected from the group encompassing or consisting of platinum, palladium, ruthenium, aluminum, tungsten, titanium, vanadium, and mixtures thereof, more particularly encompassing or consisting of titanium and vanadium, and optionally tungsten.

In a ninth embodiment, the invention relates to a filter candle according to embodiment 8, characterized in that the metal of the metal compound is selected from the group encompassing or consisting of titanium and vanadium, the mass ratio of titanium compound to vanadium compound being 100:1 to 10:1, preferably from 75:1 to 15:1, more preferably from 60:1 to 20:1, more particularly of 30:1.

According to a tenth embodiment, the invention relates to a filter candle according to any of the preceding embodiments, characterized in that the catalyst solution has a total content of metal compound(s) of 1 to 10 wt %, preferably of 3 to 8 wt %, more preferably of 4 to 7 wt %, more particularly of 4.5 to 6 wt %, based in each case on the total weight of the catalyst solution.

According to an eleventh embodiment, the invention relates to a filter candle for cleaning exhaust gases, more particularly for cleaning industrial exhaust gases, preferably for cleaning exhaust gases from waste incineration plants, comprising a hollow filter candle body and at least one catalytically active metal compound, characterized in that the wall of the filter candle body has a concentration gradient of the catalytically active metal compound.

According to a twelfth embodiment, the invention relates to a filter candle according to any of the preceding embodiments, characterized in that the concentration of the metal compound(s) increases in a gradient from outside to inside across the wall thickness of the filter candle body 2.

According to a thirteenth embodiment, the invention relates to a filter candle according to any of the preceding embodiments, characterized in that the concentration of the catalytically active metal compound on the wall outside of the hollow filter candle body is from 1.5 to 90%, preferably 5 to 85%, more preferably 10 to 80%, very preferably 20 to 80%, more preferably still 40 to 80%, more especially preferably 50 to 80%, of the concentration of the catalytically active metal compound on the wall inside of the hollow filter candle body.

According to a fourteenth embodiment, the invention relates to a method for producing a filter candle according to embodiments 1 to 13, the method comprising the following method steps in the specified order:
a) providing a hollow filter candle body 2,
b) impregnating the inside 3 of the filter candle body 2 provided in step a) with a catalyst solution comprising at least one solvent, preferably water, and at least one metal compound dissolved and/or dispersed in the at least one solvent,
c) drying the impregnated filter candle body 2 obtained in step b), and
d) thermally activating the filter candle body 2 obtained in step c).

According to a fifteenth embodiment, the invention relates to a method for producing a filter candle according to embodiment 14, characterized in that the impregnation in step b) takes place by spraying, more particularly by means of a spray lance movable in longitudinal direction within the filter candle body 2.

According to a sixteenth embodiment, the invention relates to the use of a filter candle according to embodiments 1 to 13 or of a filter candle obtainable by the method according to embodiments 14 or 15 for exhaust gas cleaning, more particularly for cleaning industrial exhaust gases, preferably for cleaning exhaust gases from waste incineration plants.

According to a seventeenth embodiment, the invention relates to an apparatus for producing a filter candle according to embodiments 1 to 13, the apparatus comprising a reservoir vessel 10 for the catalyst solution, said vessel being provided optionally with a stirring facility 11 and there being a conduit 12 which starts from the reservoir vessel 10 and via which the catalyst solution can be conveyed by means of a conveying facility 13 into a spraying lance 14 which is held moveably in longitudinal direction, for the inside impregnation of the filter candle body 2, the apparatus further comprising a holder for the filter candle body 2 that is equipped optionally with a drive unit for setting the filter candle body 2 into rotation about its longitudinal axis.

According to an eighteenth embodiment, the invention relates to an apparatus according to embodiment 17, characterized in that in the region above the holder there is a suction withdrawal unit 17 and/or below the holder there is a collecting vessel 18 for excess catalyst solution.

According to a nineteenth embodiment, the invention relates to an apparatus according to embodiments 17 or 18, characterized in that the holder is formed by a plurality of rollers for rotatably mounting the filter candle body 2, at least one of the rollers being equipped with the drive unit.

According to a twentieth embodiment, the invention relates to an apparatus according to embodiments 17, 18 or 19, characterized in that the holder has a stop facility, movable preferably via a rail, for locating the filter candle body 2.

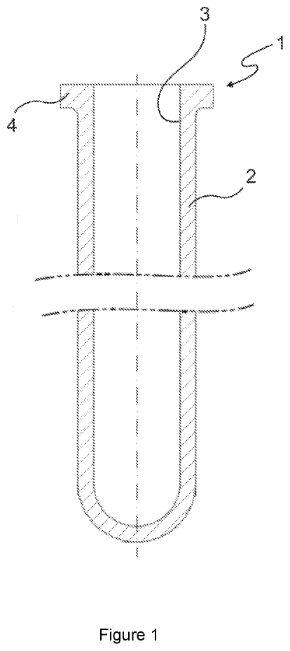

The present invention is elucidated below in more detail with reference to FIGS. 1 to 11 and also to the subsequent examples. In the figures,

FIG. 1 shows a longitudinal section through a filter candle 1 of the invention;

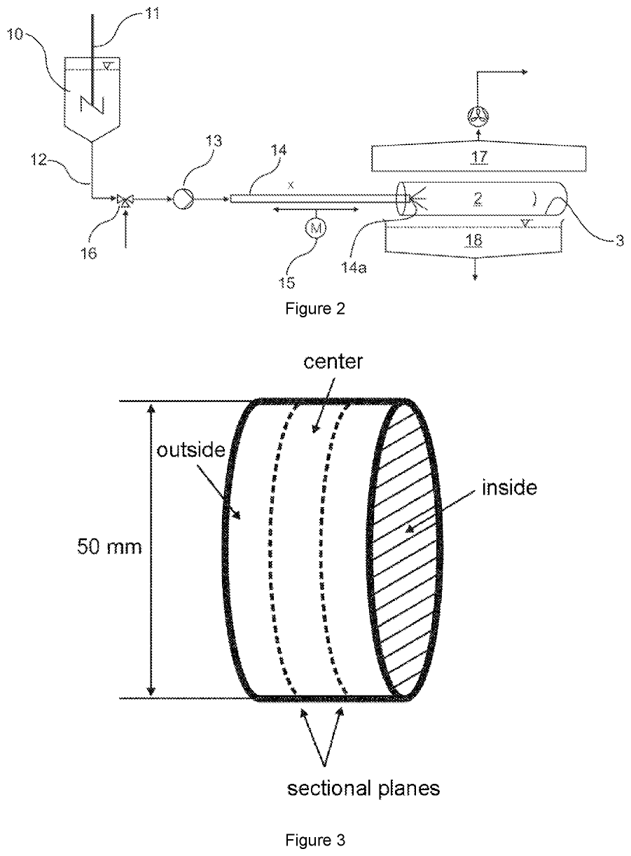

FIG. 2 shows a schematic representation of a plant for coating the filter candles with a catalyst;

FIG. 3 shows a schematic representation of a roundel having a 50 mm diameter from a filter candle of the invention with a wall thickness of 20 mm as a sample for determination of the local catalyst concentration via EDX;

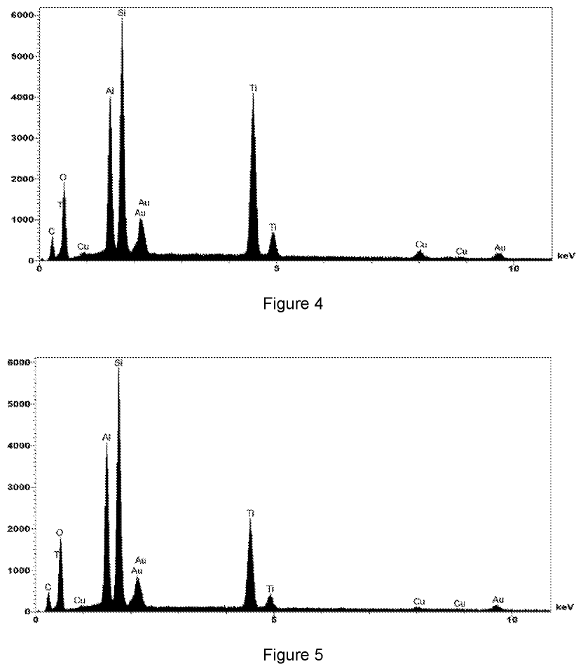

FIG. 4 shows an EDX spectrum close to the inside of a roundel corresponding to FIG. 3;

FIG. 5 shows an EDX spectrum at a distance of 3 mm from the inside of the roundel from FIG. 4;

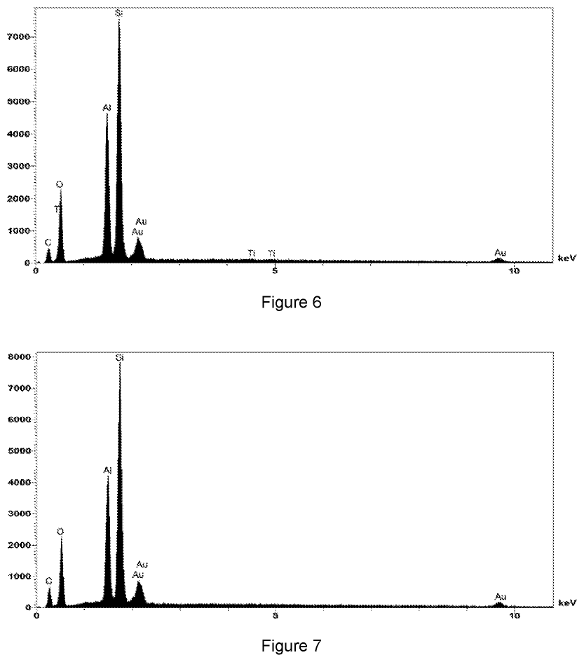

FIG. 6 shows an EDX spectrum at a distance of 8 mm from the inside of the roundel from FIG. 4;

FIG. 7 shows an EDX spectrum at a distance of 14 mm from the inside of the roundel from FIG. 4;

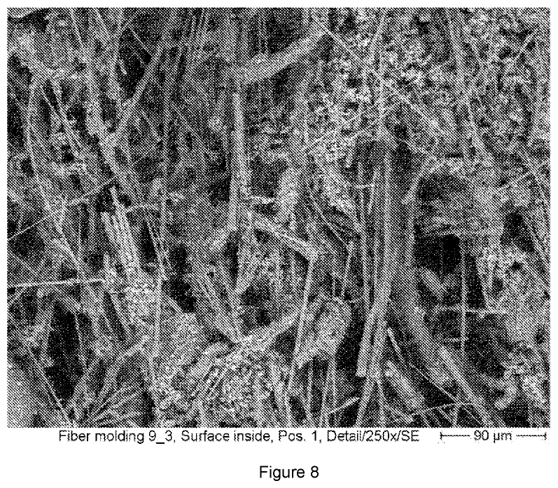

FIG. 8 shows a scanning electron micrograph close to the inside of the roundel corresponding to FIG. 3;

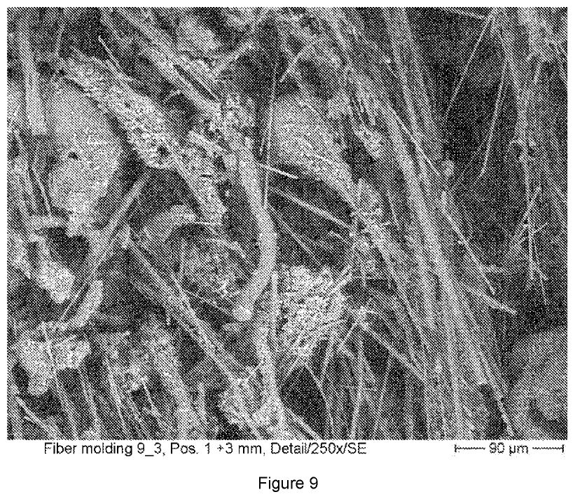

FIG. 9 shows a scanning electron micrograph at a distance of 3 mm from the inside of the roundel from FIG. 8;

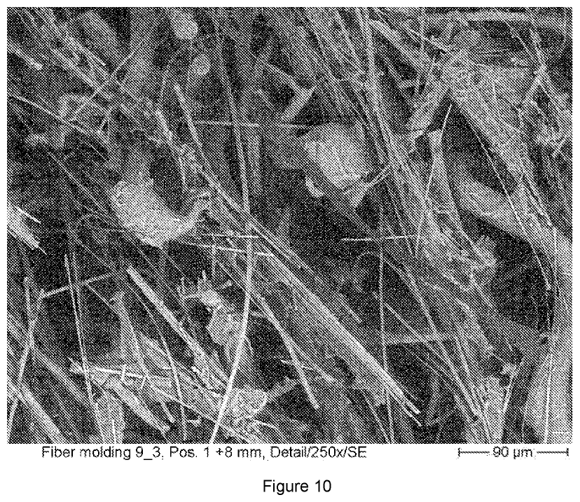

FIG. 10 shows a scanning electron micrograph at a distance of 8 mm from the inside of the roundel from FIG. 8;

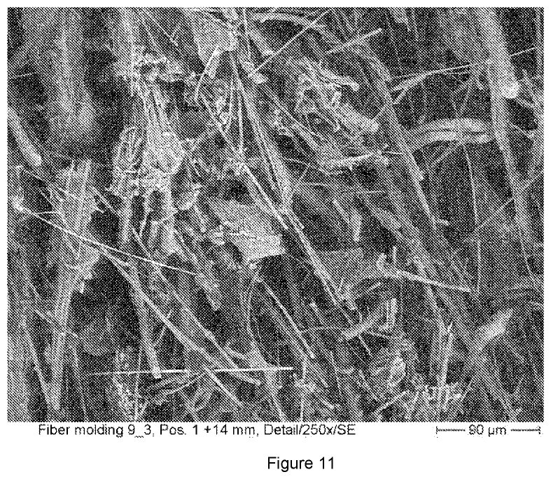

FIG. 11 shows a scanning electron micrograph at a distance of 14 mm from the inside of the roundel from FIG. 8.

FIG. 1 shows a longitudinal section through a schematically represented filter candle 1 of the invention. The filter candle 1 comprises a hollow filter candle body 2, which is constructed substantially of aluminum silicate fibers. The filter candle body 2 has a collar element 4 at one end thereof and is closed in a dome shape at the opposite end. The filter candle body 2 possesses a length of 4000 mm and a wall thickness of about 20 mm in the region outside the collar element 4. In the region outside the collar element 4, the inside diameter is 110 mm and the outside diameter is 150 mm. The collar element 4 finishes flush with the inside of the region outside the collar element 4 and projects beyond said collar element 4 on the outside. The collar element 4 therefore likewise possesses an inside diameter of 110 mm and a greater outside diameter of 195 mm. The collar element 4 also has a height of 30 mm and a width of 42.5 mm.

The filter candle body 2 is impregnated exclusively on the inside 3 with a catalyst solution as specified in more detail in the examples below, so producing a concentration gradient from inside to outside in the wall of the filter candle body 2.

FIG. 2 shows a schematic representation of an apparatus for impregnating a filter candle body 2 according to FIG. 1 with a catalyst. The apparatus comprises a reservoir vessel 10 for the catalyst solution, which has a stirring facility 11. Leaving from the underside of the reservoir vessel 10 is a conduit 12 through which the catalyst solution can be conveyed by means of a conveying facility, configured as pump 13, into a spraying lance 14, held moveably in longitudinal direction, for impregnating the inside of the filter candle body 2. The spraying lance 14 at its end carries a conical nozzle 14a having a nozzle diameter of 4 mm, and is coupled to a motor drive 15 with which the longitudinal-side displacement of the spraying lance 14 can be accomplished. In the conduit 12, in the portion of conduit between the reservoir vessel 10 and the pump 13, there is a three-way valve 16, which serves for flushing/cleaning.

The apparatus additionally has a holder, not presently represented, for the filter candle body 2. This holder is formed by a plurality of rotatably mounted, rubberized roller pairs, of which one roller pair is provided with a motor drive unit in order to set the roller into rotation. Speed and direction of the rotary movement are adjusted via a controller, which is not shown. A stop facility movable via a rail, and likewise not shown, ensures that the collar element 4 of the filter candle body 2 always remains at a defined point even when it is rotating due to the motor-driven rollers, independently of the length of the filter candle body 2. Above the holder for the filter candle body 2 there is a suction withdrawal unit 17 for any spray mists that emerge. Positioned below the holder is a collecting vessel 18 for collecting excess catalyst solution or for removing flushing water.

In operation of the apparatus represented in FIG. 2, a filter candle body 2 is placed onto the rubberized roller pairs of the holder, with the collar element 4 of the filter candle body 2 being located by the stop facility not presently shown. The spraying lance 14 is centered in the filter candle body 2 and advanced up to a preadjustable point in the direction of the end piece of the filter candle body 2, by means of the motor drive 15. When this point has been reached, the motor-driven roller pair is started and the filter candle body 2 is set into rotation. The pump 13 as well is engaged at this point, and the catalyst solution is consequently sprayed onto the inside 3 of the filter candle body 2. A spraying pressure of 6 bar is established here. On the backward movement of the spraying lance 14 that is initiated at the same time, out of the filter candle body 2, the spraying operation is ended before the lance tip with the conical nozzle 14a leaves the filter candle body 2. This spraying operation is carried out at least once. If required, however, this operation may be repeated twice, three, four or five times, or more often. By repeating the spraying operation it is possible to increase the concentration of the catalyst in the filter candle body, with further maintenance of the concentration gradient within the wall thickness.

The filter candle body 2 thus impregnated is then dried at 100° C. for twelve hours and subsequently subjected to a thermal activation at 500° C. for 4 h, after which the filter candle 1 is complete.

FIG. 3 shows a schematic representation of a sample from a filter candle 1 of the invention in the form of a roundel having a diameter of 50 mm and a wall thickness of 20 mm of a filter candle of the invention in longitudinal section, this roundel having been taken from the filter candle 1 using a hole saw. In accordance with the regions shown in FIG. 3, the measurements were conducted across the thickness from inside, from the center, and from outside of the 50 mm roundel. FIGS. 4 to 7 show the x-ray spectra of these samples, obtained by means of energy-dispersive x-ray spectroscopy (EDX). It is apparent that with increasing distance from the inside of the filter candle, the concentration of titanium goes down and there is therefore a concentration gradient.

This can be recognized qualitatively not least from the scanning electron micrographs in FIGS. 8 to 11. These show the images, taken by a scanning electron microscope, of the regions used in FIGS. 1 to 7. These scanning electron microscope images were taken at a resolution of 90 μm. In the samples close to the inside of the filter candle 1, the deposits of the catalytic metal compounds are clearly apparent as small crystalline structures on the relatively smooth fiber surface of the filter candle body 2, and are delimited optically by the significantly lighter color. For the samples of the outside in FIGS. 9 and 10, these structures can virtually not be seen. The concentration gradient is therefore apparent simply from SEM micrographs.

Filter Candle 1 Example

A filter candle generated in accordance with the production method described for FIG. 2 and composed of aluminum silicate wool (ASW), the impregnation having taken place with a 5 wt % catalyst suspension containing 4.84 wt % of TiO₂ and 0.16 wt % of V₂O₅. The impregnation rate was adjusted such that 5 kg of the aforesaid catalyst suspension were applied to the inside of the hollow filter candle body with the dimensions given above for FIG. 1. The solvent used was water and the dispersant employed was polyethylene glycol. The concentration of catalyst (sum total of TiO₂ and V₂O₅) within the wall thickness after drying was 16 wt % on the inside, 13 wt % at the center and 9 wt % on the outside, measured in each case at a third of the wall thickness.

Filter Candle 2 Example

A filter candle generated in accordance with the production method described for FIG. 2 and composed of aluminum silicate wool (ASW), the impregnation having taken place with a 7.5 wt % catalyst suspension containing 7.26 wt % of TiO₂ and 0.24 wt % of V₂O₅. The impregnation rate was adjusted such that around 5 kg of the aforesaid catalyst suspension were applied to the inside of the hollow filter candle body with the dimensions given above for FIG. 1. The solvent used was water and the dispersants employed were polyacrylates. The concentration of catalyst (sum total of TiO₂ and V₂O₅) within the wall thickness after drying was 19 wt % on the inside, 17 wt % at the center and 14 wt % on the outside, measured in each case at a third of the wall thickness.

Filter Candle 3 Example

A filter candle generated in accordance with the production method described for FIG. 2 and composed of aluminum silicate wool (ASW), the impregnation having taken place with a 5 wt % catalyst suspension containing 4.9 wt % of TiO₂ and 0.1 wt % of V₂O₅. The impregnation rate was adjusted such that 6 kg of the aforesaid catalyst suspension were applied to the inside of the hollow filter candle body with the dimensions given above for FIG. 1. The solvent used was water and the dispersants employed were polyacrylates. The concentration of catalyst (sum total of TiO₂ and V₂O₅) within the wall thickness after drying was 18 wt % on the inside, 16 wt % at the center and 12 wt % on the outside, measured in each case at a third of the wall thickness.

Filter Candle 4 Example

A filter candle generated in accordance with the production method described for FIG. 2 and composed of alkaline earth metal silicate wool (AES), the impregnation having taken place with a 5 wt % catalyst suspension containing 4.84 wt % of TiO₂, 1.8 wt % of WO₃ and 0.16 wt % of NH₄VO₃. The impregnation rate was adjusted such that around 5 kg of the aforesaid catalyst suspension were applied to the inside of the hollow filter candle body. The solvent used was water and the dispersants employed were polyacrylates. The concentration of catalyst (sum total of TiO₂, WO₃ and V₂O₅) within the wall thickness after drying was 18 wt % on the inside, 14 wt % at the center and 10 wt % on the outside, measured in each case at a third of the wall thickness.

### LIST OF REFERENCE SYMBOLS

1 Filter candle
2 Hollow filter candle body
3 Inside of filter candle body
4 Collar element
10 Reservoir vessel
11 Stirring facility
12 Conduit
13 Conveying facility/pump
14 Spraying lance
14a Conical nozzle
15 Motor drive
16 Three-way valve
17 Suction withdrawal unit
18 Collecting vessel

1. A filter candle for exhaust gas cleaning, the filter candle being obtainable by:
a) providing a hollow filter candle body,
b) impregnating an inside of the filter candle body provided in step a) with a catalyst solution comprising at least one solvent and at least one metal compound dissolved and/or dispersed in the at least one solvent to yield an impregnated filter candle body,
c) drying the impregnated filter candle body obtained in step b) to yield a dried impregnated filter candle body, and
d) thermally activating the dried impregnated filter candle body obtained in step c).

2. The filter candle as claimed in claim 1, wherein the filter candle body comprises or consists of inorganic fibers.

3. The filter candle as claimed in claim 2, wherein the inorganic fibers are selected from the group of ceramic fibers, glass fibers, crystalline mineral fibers, amorphous mineral fibers, mineral wood, high-temperature wool, carbon fibers, and mixtures thereof.

4. The filter candle as claimed in claim 1, wherein the filter candle has a porosity of 70 to 95%, the porosity having been ascertained through a determination of water absorption according to DIN EN 993-1:2019 DE.

5. The filter candle as claimed in claim 1, wherein the filter candle body has a collar element at one end and is closed at an opposite end.

6. The filter candle as claimed in claim 1, wherein the filter candle body is obtainable by:
i) preparing an optionally aqueous suspension which comprises inorganic fibers and at least one binder system,
ii) drawing the suspension prepared in step i) by suction onto a candle-shaped absorbent core for the shaping of the filter candle body, and
iii) drying the filter candle body shaped in step ii).

7. The filter candle as claimed in claim 6, wherein the binder system comprises or consists of starch and at least one colloidal dispersion.

8. The filter candle as claimed in claim 1, wherein the metal of the metal compound is selected from the group comprising or consisting of platinum, palladium, ruthenium, aluminum, tungsten, titanium, vanadium, and mixtures thereof.

9. The filter candle as claimed in claim 8, wherein the metal of the metal compound is selected from the group comprising or consisting of titanium and vanadium, a mass ratio of titanium compound to vanadium compound being 100:1 to 10:1.

10. The filter candle as claimed in claim 1, wherein the catalyst solution has a total content of metal compound(s) of 1 to 10 wt %, on a total weight of the catalyst solution.

11. A filter candle for cleaning exhaust gases, comprising a hollow filter candle body and at least one catalytically active metal compound, wherein a wall of the filter candle body has a concentration gradient of the catalytically active metal compound.

12. The filter candle as claimed in claim 1, wherein the concentration of the metal compound(s) increases in a gradient from outside to inside across the wall thickness of the filter candle body.

13. The filter candle as claimed in claim 1, wherein a concentration of the catalytically active metal compound on a wall outside of the filter candle body is from 1.5 to 90% of a concentration of the catalytically active metal compound on a wall inside of the filter candle body.

14. A method for producing a filter candle as claimed in claim 1, the method comprising the following method steps in the specified order:
a) providing a hollow filter candle body,
b) impregnating an inside of the filter candle body provided in step a) with a catalyst solution comprising at least one solvent and at least one metal compound dissolved and/or dispersed in the at least one solvent to yield an impregnated filter candle body,
c) drying the impregnated filter candle body obtained in step b) to yield a dried impregnated filter candle body, and
d) thermally activating the dried impregnated filter candle body obtained in step c).

15. The method as claimed in claim 14, wherein the impregnating in step b) takes place by spraying.

16. A method of using a filter candle as claimed in claim 1 for exhaust gas cleaning.

17. An apparatus for producing a filter candle as claimed in claim 1, the apparatus comprising a reservoir vessel for the catalyst solution, said vessel being provided optionally with a stirring facility and there being a conduit which starts from the reservoir vessel and via which the catalyst solution can be conveyed by means of a conveying facility into a spraying lance which is held moveably in longitudinal direction, for the inside impregnation of the filter candle body, the apparatus further comprising a holder for the filter candle body that is equipped optionally with a drive unit for setting the filter candle body into rotation about its longitudinal axis.

18. The apparatus as claimed in claim 17, wherein in a region above the holder there is a suction withdrawal unit and/or below the holder there is a collecting vessel for excess catalyst solution.

19. The apparatus as claimed in claim 17, wherein the holder is formed by a plurality of rollers for rotatably mounting the filter candle body, at least one of the rollers being equipped with the drive unit.

20. The apparatus as claimed in claim 17, wherein the holder has a stop facility for locating the filter candle body.
